(19) United States
(12) Patent Application Publication
(10) Pub. No.: US 2007/0132644 A1
(43) Pub. Date: Jun. 14, 2007

(54) Antenna structure for multiple input and output signals

(75) Inventors: Shih-Chung Chen, Yuanli Township (TW); Chung-Ta Wu, Taoyuan City (TW); Chih-Sen Hsieh, Houli Township (TW)

Correspondence Address: EGBERT LAW OFFICES, 412 MAIN STREET, 7TH FLOOR, HOUSTON, TX, 77002, US

(73) Assignee: Wha Yu Industrial Co., Ltd., Hsinchu City (TW)

(21) Appl. No.: 11/362,575

(22) Filed: Feb. 27, 2006

(30) Foreign Application Priority Data
Dec. 9, 2005 (TW) 094221582

(51) Int. Cl. H01Q 1/38

(52) U.S. Cl. 343/700 MS; 343/795

(57) ABSTRACT

The present invention provides an antenna structure for input and output signals, which includes multiple antenna units and a carrier. The carrier has a first and second bearing surface, the first bearing surface of the carrier having multiple antenna units placed on it separately, so that the loading structure of the antenna units goes through the first bearing surface to the second bearing surface. A boring hole is placed on the carrier, and the boring hole is used to secure the carrier with antenna units on a object. Through this invention, the antenna uses the carrier to integrate the module and makes the antenna structure for multiple input and output signals.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an antenna structure, and more particularly to an antenna structure for multiple input and output signals.

### BACKGROUND OF THE INVENTION

Today's wireless network is close to a well-structured development; however, the complication of data transmission increases as the demand of the users increases. For example, high quality audio/video transmission or large sizes of data transmission must have larger bandwidth and transmission rate. Because of these reasons, the used transmission rates in wireless application do not meet today's wireless network demands. In terms of WLAN, the most common standard is 802.11A/B/G, and the fastest speed theoretically is 11˜54 MBPS; however, for users, the need for a broader band is never ending.

So as to make a breakthrough on the transmitting speed of WLAN, the future WLAN technology is in the process of intensive development. The new WLAN standard for the next generation established by IEEE is 802.11N, such that one of the objectives is to upgrade the current fastest transmission speed from 54 MBPS to be more than 100 MBPS. The most important technology in today's wireless transmitting area is multiple input and output signal technology, so that the current transmitting effect can have important improvements and breakthroughs. This technology increases the signal transmission rate by increasing antennas and RF modules. For this reason, how to develop an antenna structure for electronic equipment that has multiple input and output signal is the area the industry needs to put in its effort to develop.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

From the abovementioned statement, the present invention has the following advantages.

1. The present invention provides an antenna structure for multiple input and output signals, which uses a carrier 20 to secure multiple antenna units 10 so that the multiple antenna units 10 may be integrated into a single module to transmit/receive several data steams.

2. The present invention provides an antenna structure for multiple input and output signals, which have multiple antenna units 10 placed on a carrier 20 separately, so that the repair and modification of the antenna units 10 can be done under one module for easy maintenance and assembly.

3. The present invention provides an antenna structure for multiple input and output signals, because the electrical circuit or electronic components may be added onto the carrier 20, or the carrier 20 may be used as a ground for all antenna units 10 to adjust the antenna units' 10 radiation or impedance matching or radiation pattern or antenna gain to meet the antenna units 10's radiation demand.

4. The present invention provides an antenna structure for multiple input and output signals, which uses carrier 20 to integrate multiple antenna units 10 so that the multiple antenna units 10 can be integrated in a certain space, and so that it does not waste the space and does not affect the convenience of the movement.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the present invention.

FIG. 2 shows an exploded perspective view of the present invention.

FIG. 3 shows a perspective view of the antenna casing of the present invention.

FIG. 4 shows a perspective view of another preferred embodiment of the antenna casing of the present invention.

FIG. 5 shows a front elevation view of a surface of another preferred embodiment of the carrier of the present invention.

FIG. 6 shows a front elevation view of a surface of another preferred embodiment of the carrier of the present invention

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

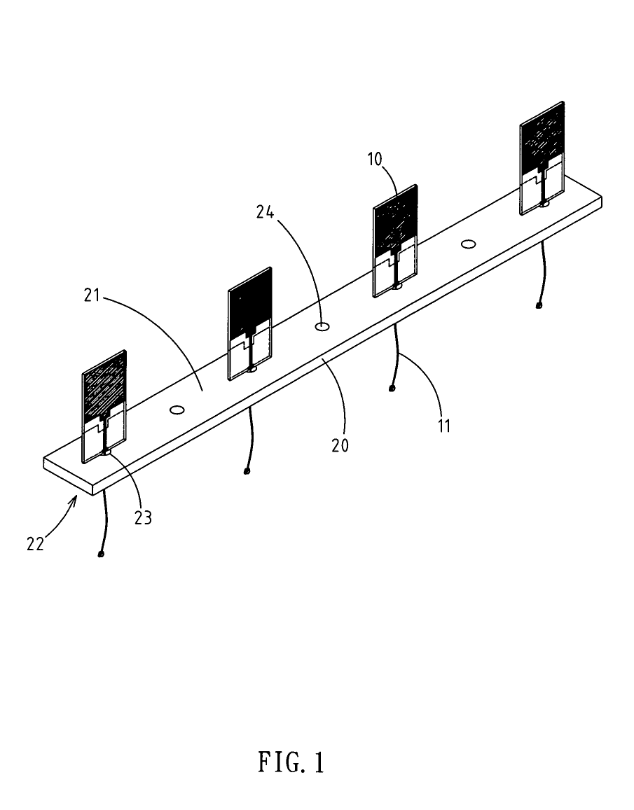

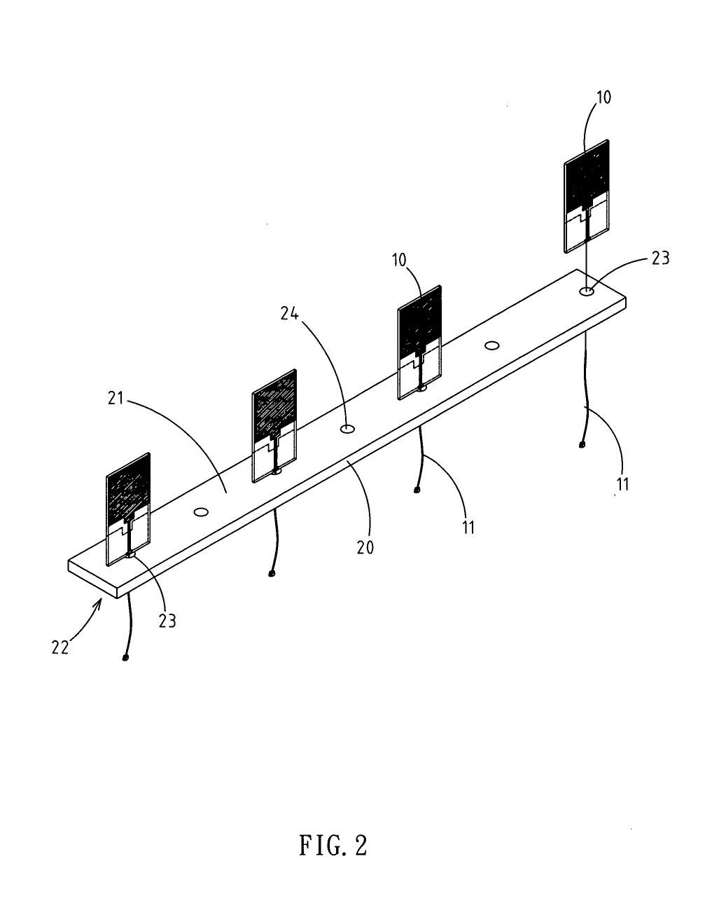

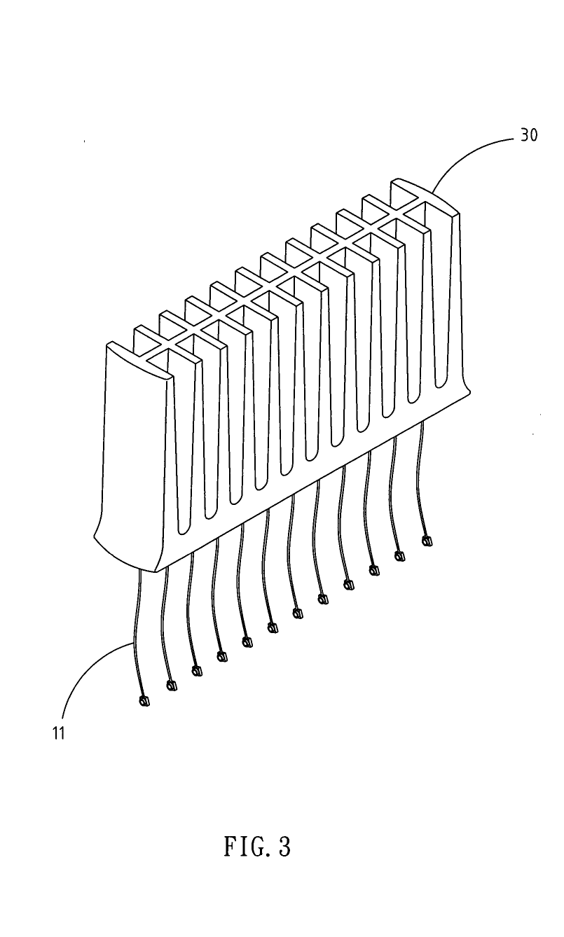

As shown in FIGS. 1˜2, there is an antenna structure for multiple input and output signals.

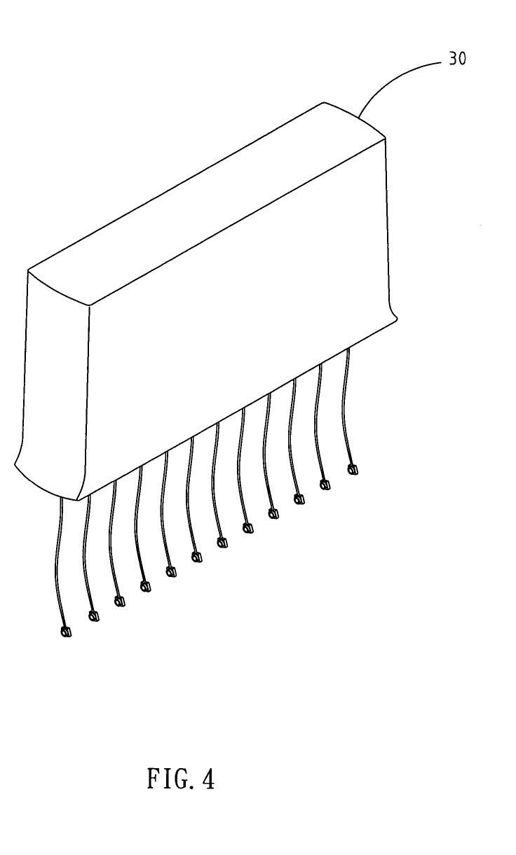

The invention includes multiple antenna units 10 and a carrier 20. The carrier 20 has a first and second bearing surfaces 21 22, among them, the first bearing surface 21 of the carrier having multiple antenna units 10 placed upon it separately, and the feeding structure of each antenna units 10 going through the first bearing surface 21 to the second bearing surface 22. The feeding structure can be a coaxial cable 11 or a connector, and through hole 23 can be made on the carrier 20 in accordance with the antenna units 10 so that the coaxial cable 11 can come through the through hole 23. A boring hole 24 may be placed on the carrier 20, and the boring hole 24 may be used with screws to secure the carrier 20 and antenna unit 10 on an object, such as securing it inside an antenna casing 30 (such as FIGS. 3 and 4) or on a base, and further becoming an integrated antenna structure needed for the wireless electronic device with multiple input and output signals.

The antenna structure for multiple input and output signals of the present invention has an antenna unit 10, such that being shaped flat is the best.

In the antenna structure for multiple input and output signals of the present invention, the electrical circuit or electronic components may be added to the carrier 20 to adjust the radiation or impedance matching or radiation pattern, and the carrier 20 may also be used as a ground for the antenna unit to meet the radiation demand of the antenna unit 10.

The antenna structure of the present invention comprises multiple antenna units 10 and a carrier 20. The carrier 20 has multiple antenna units 10 placed upon them separately, and each feeding structure of the antenna units 10 goes through the outside of the carrier 20. The electrical circuit or electronic components may be added on the carrier 20 so that the feeding structures (such as the coaxial cable 11 or connector) of the multiple antenna units 10 can be integrated into a single feeding structure. The antenna unit 10 can integrate the radiation signal and can enhance the antenna's gain.

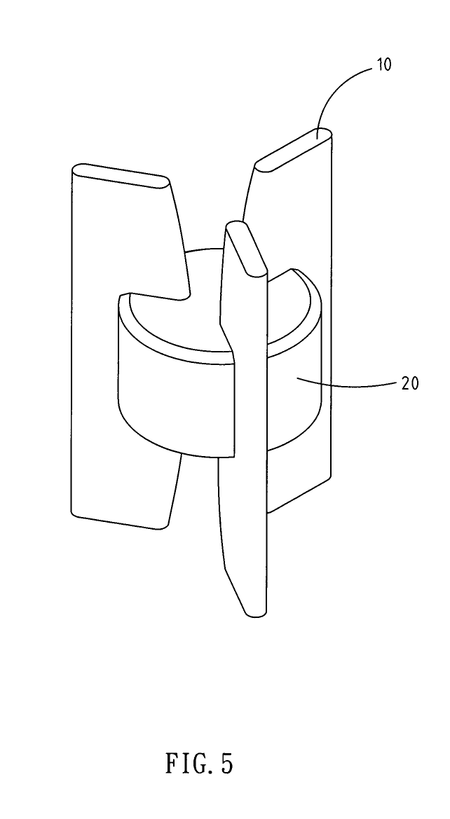

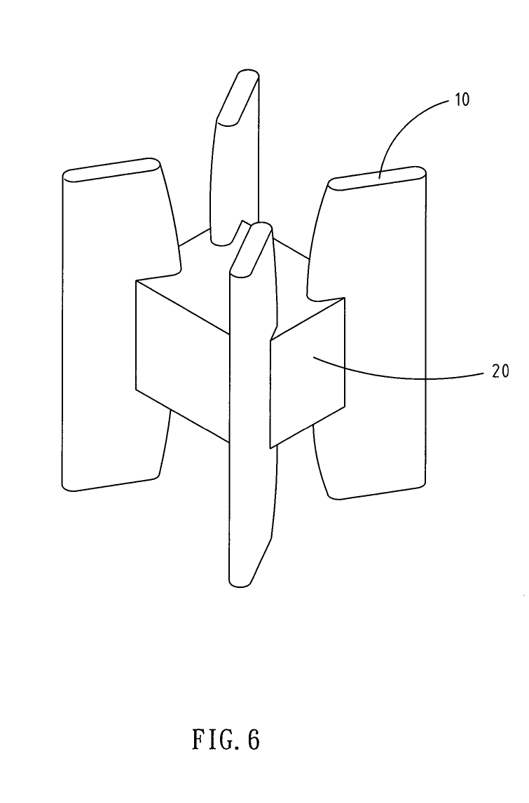

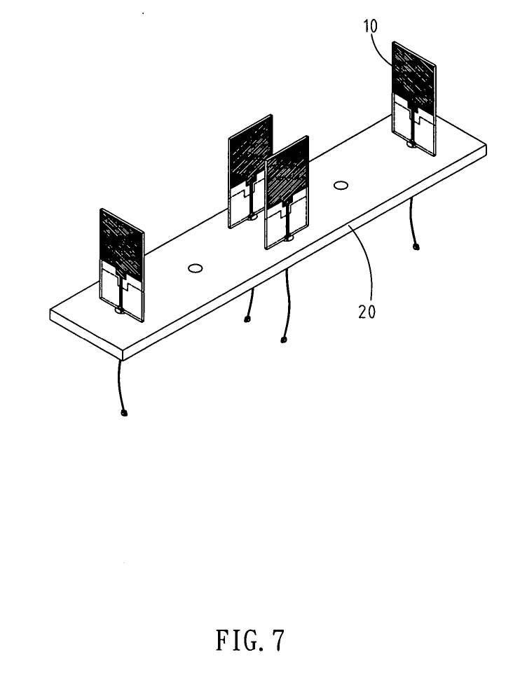

As shown in FIGS. 5 and 6, there is another preferred embodiment of the carrier of the present invention. As shown in the figure, an antenna structure of the present invention comprises multiple antenna units 10 and a carrier 20, and the carrier 20 has multiple antenna units 10 placed on it separately. Among them, the shape of the carrier 20 can be modified into different shapes to meet the demands of the system.

We claim:

1. An antenna structure for multiple input and output signals, comprising:
multiple antenna units; and
a carrier, said carrier having said multiple antenna units placed separately thereon, each antenna unit having a feeding structure so as to form an integrated antenna structure needed for electronic equipment that has multiple input and output signal in a wireless application.

2. The structure defined in claim 1, wherein said feeding structure is a coaxial cable.

3. The structure defined in claim 1, wherein said feeding structure is a connector.

4. The structure defined in claim 1, wherein said antenna unit is comprised of flat shape antenna.

5. The structure defined in claim 1, wherein said carrier has a boring hole placed thereon, said boring hole being used with screws to secure the antenna unit to an inside or a base of an antenna casing.

6. The structure defined in claim 1, wherein said carrier is a ground for the antenna units.

7. The structure defined in claim 1, wherein said carrier is modifiable into different shapes to meet demands of a system.

8. An antenna structure for multiple input and output signals comprising:
multiple antenna units; and
a carrier, said carrier having said multiple antenna units placed separately thereon, each antenna unit having a feeding structure and electrical circuit or electronic components added on said carrier so as to adjust radiation, impedance matching, radiation pattern of said multiple antenna units and so as to meet input and output signal demands of said multiple antenna units.

9. The structure defined in claim 8, wherein said carrier can be used as a ground for the antenna units.

10. The structure defined in claim 8, wherein said carrier is modifiable into different shapes to meet demands of a system.

11. An antenna structure for multiple input and output signals, comprising:
multiple antenna units; and
a carrier, said carrier having multiple antenna units placed separately thereon, an antenna unit having a feeding structure and electrical circuit or electronic components added on said carrier, said feeding structures being able to integrate electricity to a single feeding structure.

12. The structure defined in claim 11, wherein said feeding structure is a coaxial cable.

13. The structure defined in claim 11, wherein said feeding structure is a connector.

14. The structure defined in claim 11, wherein said carrier can be used as a ground for the antenna units.

15. The structure defined in claim 11, wherein said carrier is modifiable into different shapes to meet demands of a system.
